(19) United States
(12) Patent Application Publication
(10) Pub. No.: US 2010/0088104 A1
(43) Pub. Date: Apr. 8, 2010

(54) Systems and methods for providing real-time data notification and related services

(76) Inventors: Robert DeRemer, York, PA (US); Robert Hallquist, JR., New Holland, PA (US); Martin Kreibe, Wilmington, DE (US)

Correspondence Address: SAP / FINNEGAN, HENDERSON LLP, 901 NEW YORK AVENUE, NW, WASHINGTON, DC, 20001-4413, US

(21) Appl. No.: 12/285,465

(22) Filed: Oct. 6, 2008

(51) Int. Cl. G06Q 10/00; G06F 15/16; G06Q 30/00

(52) U.S. Cl. 705/1.1; 709/206

(57) ABSTRACT

Systems and methods are provided for real-time data notification. In accordance with one implementation, a computerized method is provided that includes defining an event related to a resource in accordance with input from a first subscriber, and allowing a second subscriber to subscribe to a message concerning the event defined by the first subscriber. The method also includes receiving data generated by a reporter module, the reporter module being configured to monitor at least one attribute of the resource, and interpreting the data generated by the reporter module to determine the occurrence of the event defined by the first subscriber. In addition, the method includes delivering, when it is determined that the event has occurred, a message to the first subscriber, the message including content concerning the event. Additionally, the message concerning the event may be delivered to the second subscriber.

### BACKGROUND

I. Technical Field

The present invention generally relates to the field of data processing and to data monitoring and notification services. More specifically, and without limitation, the invention relates to systems and methods that provide real-time data notification and related services for various environments, such as manufacturing and other business environments.

II. Background Information

Communication in businesses is undergoing fundamental changes as a result of the advent of new technologies, such as communication networks and computer networked systems. For example, an online book retailer may rely heavily on computers to connect its order processing systems with book suppliers. After receiving an order request, the online book retailer may notify their book suppliers to fulfill the order through one or more networked systems. To increase efficiency, the online store may choose a supplier closest to the customer who made the order, in order to save cost and time. The ordering process may be disrupted, however, when the supplier's remote system fails to operate due to an unforeseeable event, such as a device failure. In such a case, the ability to quickly detect the failure could become very important. The book retailer may avoid an unnecessary customer dispute by immediately arranging another supplier to fulfill the order. If the damage is substantial, the book retailer may consider further options to prevent similar situations from occurring in the future, such as to terminate the business relationship with the supplier and seek a replacement.

The above example illustrates the need for real-time data notification and related services in a business environment. In many business environments, the need for real-time monitoring and notification is critical to achieve throughput and efficiency for various activities. Other examples exist, such as manufacturing environments, where key components on a shop or plant floor are relied upon for satisfying production demands and/or performance schedules. Should any piece of equipment fail or should supplies be limited, real-time data notification is necessary to address and correct each problem or failure.

In many manufacturing and other business environments, different computerized systems or components may exist. Because these systems or components may have different standards with respect to, for example, data format, connectivity and/or communication, it is often difficult to provide real-time data notification and handling. These difficulties may exist where data processing and communication is attempted between different business environments, which implement different standards and protocols. Moreover, in manufacturing environments, there may be similar difficulties due to various standards and vendor-specific manufacturing systems.

In view of the foregoing, there is a need for systems and methods that facilitate real-time data notification in an efficient manner. There is also a need for systems and methods that provide data notification and/or other related services between different components or sources of data. In addition, there is a need for a solution that permits user-defined events combined with real-time data notification for manufacturing and other business environments.

### SUMMARY

Embodiments of the present invention relate to systems and methods for providing data monitoring and notification. Certain embodiments of the invention allow subscribers to receive real-time notification of events that are detected based on data generated by a reporter module. An event may be defined by a subscriber and relate to an attribute of a resource in a monitored environment. Reporter modules may generate data based on one or more monitored attributes of a resource. In one embodiment, a reporter module is a pluggable component and can be added or updated in a flexible manner without disturbing other reporter modules.

Consistent with certain embodiments of the invention, messenger modules are provided to send event notifications, in the form of messages, to subscribers. Messages may include content that conveys information concerning a monitored event. Events may be defined based on input provided by a subscriber. In addition, subscribers may subscribe to receive notifications concerning events defined by other subscribers.

Embodiments of the invention may be implemented in various types of environments, including manufacturing and other types of business environments. In addition, in accordance with one embodiment, the invention may be implemented to provide real-time data notification concerning events related to resources in a monitored environment (e.g., a manufacturing plant) with event notifications being sent in the form of messages to subscribers in a monitoring environment (e.g., a business environment such as remote office location).

In accordance with an embodiment of the present invention, a computer-implemented method is provided for real-time data notification. The method may comprise defining an event related to a resource in accordance with input from a first subscriber, and receiving data generated by a reporter module, the reporter module being configured to monitor at least one attribute of the resource. In addition, the method may comprise interpreting the data generated by the reporter module to determine the occurrence of the event defined by the first subscriber and delivering, when it is determined that the event has occurred, a message to the first subscriber, the message including content concerning the event.

The exemplary method may also allow a second subscriber to subscribe to one or more messages concerning the event defined by the first subscriber. Further, the method may include additionally delivering the message concerning the event to the second subscriber.

Consistent with another embodiment of the present invention, a computer readable storage system comprising programmable instructions adapted to perform a computer-implemented method is provided. The method may comprise receiving data generated by a reporter module. The reporter module may be configured to monitor at least one attribute related to a resource. The data may be interpreted to determine the occurrence of an event defined by a first subscriber. In addition, the method may include delivering, when it is determined that the event has occurred, a message to the first subscriber, the message including content concerning the event. If a second subscriber subscribes to messages concerning the event defined by the first subscriber, then the message may be additionally delivered to the second subscriber.

In accordance with yet another embodiment of the present invention, a system is provided for real-time data notification. The system may include a console module configured to allow a first subscriber to define an event. The system may also include a reporter module that generates data based on at least one monitored attribute of a resource. In addition, the system may include a processing module that is configured to interpret data generated by the reporter module to determine the occurrence of the event defined by the first subscriber. A messenger module may also be provided to deliver, when it is determined that the event has occurred, the message to at least the first subscriber, the message including content concerning the event.

In the exemplary system, the console module may allow a second subscriber to subscribe to one or more messages concerning the event defined by the first subscriber. Further, a messenger module may be provided to additionally deliver the message concerning the event to the second subscriber

It is to be understood that both the foregoing general description and the following detailed description are exemplary and explanatory only, and are not restrictive of the scope of the invention, described and as claimed. Furthermore, features and variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram illustrating an exemplary system, consistent with an embodiment of the present invention;

FIG. 2 shows an exemplary embodiment of a processing module and communication processes involving a messenger module and a reporter module, consistent with an embodiment of the present invention;

FIG. 3 is a flow diagram illustrating an exemplary method performed by a notification module of a processing module, consistent with an embodiment of the present invention; and

FIG. 4 is a flow diagram illustrating an exemplary method for handling and forwarding messages to messenger modules, consistent with an embodiment of the present invention.

### DETAILED DESCRIPTION

Embodiments of the present invention relate to systems and methods for providing data monitoring and notification. Certain embodiments of the invention allow subscribers to receive real-time notification of events detected in a monitored environment. The messages may be sent to subscribers who are located in a monitoring environment. The monitoring environment may be separate and/or remotely located from the monitored environment. The monitored and monitoring environments may be any type of business environment.

Consistent with an aspect of the present invention, a business environment is an environment for carrying out one or more activities. A business environment may be an internal or external business environment. As one example, a business environment may include a manufacturing shop floor for executing one or more manufacturing processes. As another example, a business environment may comprise a business environment of a third party, such as a supplier, a distributor, or a contractor. A business environment is not limited to a single facility or campus. A business environment may include any combination of one or more physical facilities, such as an office building, a manufacturing plant, a research facility, and a customer site. A business environment may involve multiple business units, including but not limited to, sales and marketing, customer services, IT operations, distributions, manufacturing, and research and development.

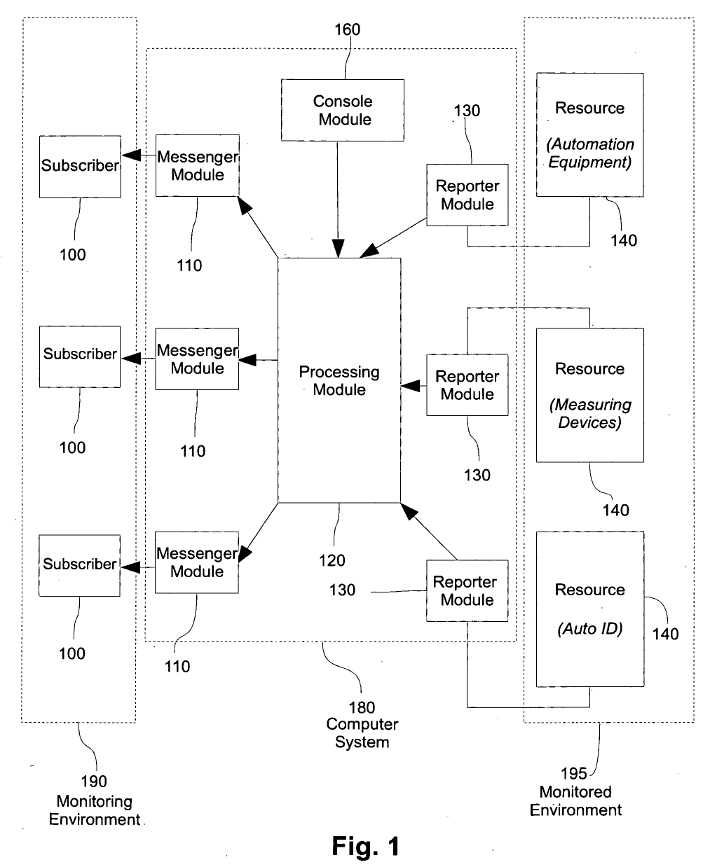

Referring to the embodiment of FIG. 1, an exemplary system is illustrated that includes a computer system 180. Consistent with an embodiment of the invention, computer system 180 may be implemented for processing data between a monitored environment 195 and a monitoring environment 190. Monitored environment 195 and monitoring environment 190 may correspond to any type of business environment. By way of example, monitored environment 195 may comprise a manufacturing plant and monitoring environment 190 may comprise a business environment, such as remote office location.

In accordance with one embodiment, computer system 180, monitored environment 195, and monitoring environment 190 may be at the same physical location. In alternative embodiment, computer system 180, monitored environment 195, and monitoring environment 190 are situated at separate locations anywhere in the world.

In the exemplary embodiment of FIG. 1, monitored environment 195 includes one or more resources 140. Each resource 140 may contribute to at least one business activities in monitored environment 195, regardless of the significance of the contribution. Resource 140 may be physically located at either the monitored environment 195 or a different business environment. Resource 140 may comprise hardware, software, or any combination thereof. By way of non-limiting example, resource 140 may be a machine, a device, an equipment, a tool, a piece of machinery, or a control system. In the context of a manufacturing environment, resource 140 may comprise automation equipment located on a manufacturing plant floor, such as a robotic machine. By way of a further example, resource 140 may also be a measuring device, such as a gauge for measuring the thickness or diameter of metal sheets.

In one embodiment, resource 140 comprises computer software or a software component, such as a software service, a software application, or a software system. For example, a software application connecting to an Auto ID device, such as a barcode scanner, a RFID reader and writer, or a smart tag, can also be a resource 140, for the purpose of inventory control.

A resource 140 may have one or more attributes. Each attribute may be any information related to the resource. In one embodiment, an attribute may include data value related to internal or external activity of a resource. As one example, an internal error message indicating a quality issue of a robotic device can be an attribute. As another example, a process exception detected by a detector can also be an attribute of the detector. Attributes are not limited to any specific data type or format. For example, an attribute may include a simple numeric value or a complicated data value, such as an array of multiple data objects. An attribute may also be represented in textual characters.

Each resource 140 may be configured to communicate data with one or more reporter modules 130 over a network or a dedicated connection. Communications between resource 140 and reporter module 130 may be made over a public network such as the Internet or a secured connection over an intranet or private network. Communications between resource 140 and reporter module 130 may also be made over a dedicated connection, such as a private lease line. Additionally, or alternatively, communications between resource 140 and reporter module 130 may be made over a wired network or a wireless network.

Consistent with the exemplary embodiment of FIG. 1, reporter modules 130 are provided as part of computer system 180. Computer system 180 may also include other components, including a processing module 120, a console module 160, and one or more messenger modules 110. These components, as well as reporter modules 130, may be implemented at the same location or different locations. In addition, each component of computer system 180 may be implemented as a software component, such as a software service, a software system, or a software application. Computer system 180 may include one or more processors (not shown) for executing software related to each component.

In computer system 180, a plurality of reporter modules 130 may be used to connect to resources 140 of different types and characteristics. Each reporter module 130 may be matched with a corresponding resource 140. Alternatively, depending on the number of attributes to be monitored, one or more reporter modules may be connected to a resource 140.

In accordance with one embodiment, a reporter module 130 is implemented as a component with a reporter module type that matches the type of a corresponding resource 140. A resource module type may match a resource based on device-level connectivity, network-level connectivity, or other types of connectivity such as open connectivity. As an example of a device-level connectivity, a report module may be implemented with a reporter module type for a Steinwald device, specifically used on the floor of a manufacturing shop. Thus, reporter modules 130 that have different module types, such as a printer device, will not be used to serve as a reporter module for a Steinwald device. In another example, an resource based on network-level connectivity, such as a TCP socket, communicates only with a reporter module 130 that communicates in TCP protocol. In a further example, a resource based on an open connectivity system of industrial automation devices and systems, such as an OPC server, may communicate only with a specific OPC based reporter module.

Consistent with an embodiment of the present invention, reporter modules 130 are implemented as pluggable components. In such as case, reporter modules may be added, updated, or removed in an efficient manner and without affecting or interrupting existing reporter modules in computer system 180. Reporter modules 130 may be implemented as pluggable components by using, for example, dynamic linked libraries (DLL).

When a reporter module 130 is created, the computer program associated with the module may be compiled into one or more dynamic libraries. These libraries, combining with the associated resource and the other components of computer system 180, are physically connected together. A handshaking procedure may be performed, so that the computer system 180 exchanges initial communications with reporter module 130 to signal that all the functions and data implemented in the reporter module 130 can be functionally supported by other components of computer system 180. When the handshaking procedure with reporter module 130 is completed, each component of computer system 180, such as processing module 130, is now ready to fully communicate with reporter module 130.

Consistent with another embodiment of the present invention, an application programming interface may be provided so that new types of reporter modules may be developed. Such an interface may comprise a set of specifications that allow users to provide the required information as specified in the specifications to develop a reporter module. The following is an example of an interface.

```
public interface IConnectivityAgent
{
    ConnectivityStates Start( );
    ConnectivityStates Stop( );
    ConnectivityStates Restart( );
    ConnectivityStates GetCurrentState( );
    void ExecuteCommand (string command, Dictionary<string, object>
inputParams, out Dictionary<string, object> outputParams);
    void ReSendFailedNotifications(string[ ] ids);
    BrowseResults Browse (BrowseSession session,
Dictionary<string,string> inputParameters, out List<BrowseData>
output>
}.
```

Consistent with an embodiment of the present invention, an application programming interface may also be provided to allow development of new types of messenger modules 110. For example, a SDK (Software Development Kit) may be provided so that users may develop new messenger modules 110 with respect to subscribers that may present special requirements.

Consistent with an embodiment of an invention, each reporter module 130 monitors and receives data from a respective resource 140. Data received from resource 140 may relate to any information regarding monitored environment 195. In one embodiment, the data includes one or more attributes of resource 140. Reporter module 130 may not only receive data, but also send data to resource 140. In one embodiment, data sent by reporter module 130 to resource 140 may include one or more commands executable by resource 140. By way of example, commands may be sent by reporter module 130 to a resource, such as a TCP socket. Exemplary commands that may be sent to a TCP socket include starting and/or stopping the socket, and sending data to the socket. Reporter module 130 may monitor one or more attributes of resource 140. Monitoring may be polled or event based. With polled-based monitoring, reporter module 130 may be configured to poll resource 140 regularly to detect any changes in a monitored attribute. Under an event-based monitoring, reporter module 130 is not required to request a resource 140 for any changed attribute data. Instead, when a change of a monitored attribute occurs, the reporter module 130 is sent an acknowledgement or other message by resource 140 that indicates the change. In one embodiment, the acknowledgement received by reporter module 130 may include the changed value of the monitored attribute. In another embodiment, the reporter module 130 receives the acknowledgement after a change of the monitored attribute occurs. In another embodiment, the reporter module 130 may receive the acknowledgement only after collecting more than one change of the monitored attribute.

Reporter module 130 may report changes in monitored attributes to processing module 120 when changes in an attribute data are detected or when an acknowledgement is sent from resource 140. For example, when an acknowledgement is received by reporter module 130 that a fire has occurred, reporter module 130 may report the change of room temperature included in the fire acknowledgement by generating an event to processing module 120. Alternatively, reporter module 130 may be configured to report a notification based on a predetermined schedule. In such a case, reporter module 130 does not generate any events when an attribute changes its value. Instead, reporter module 130 will wait until the appropriate time arrives, in view of the predetermined schedule, to generate an event to processing module 120.

The content of an event generated by a reporter module 130 may vary according to how an event is generated. The content of an event generated by reporter module 130 in response to an acknowledgement of the change of an attribute may include any information related to the acknowledgement of the change. In one embodiment, the content may include the name of the resource 140 and the name and value of the attribute for which the change took place. In another embodiment, the content of the event to be generated by the reporter module 130 may also include other information such as the reporter module 130 generating the event, and the time of receiving the acknowledgement from the resource 140.

Alternatively, when an event is generated based on a predetermined schedule, the content of an event may include the name of the resource 140, the name and value of the attribute, and the time that an attribute last changes its value. For example, the content of an event generated based on a provided schedule can be: “network port problem; port 23; 24:00.”

As shown in FIG. 1, processing module 120 is connected to one or more reporter modules 130, one or more messenger modules 110, and a console module 160. Processing module 130 is configured to receive one or more events from one or more reporter modules 130, interpret the one or more events received, determine whether a message should be generated, and communicate the message to one or more messenger modules 110. The connection between a messenger module 110 and processing module 120 may be made over an Internet or a secure intranet connection, such as private leased line. The connection between a messenger module 110 and processing module 120 may also be made over a wired or wireless connection, such as a GSM or 3G network. In addition, consistent with embodiments of the invention, each messenger module 110 may receive messages from processing module 120 using different messaging protocols. Examples of messaging protocols include Internet's Simple Mail Transfer Protocol (SMTP), IBM's SNADS, Novell's MHS, Lotus' cc:Mail, Microsoft's MS Mail, and X.400.

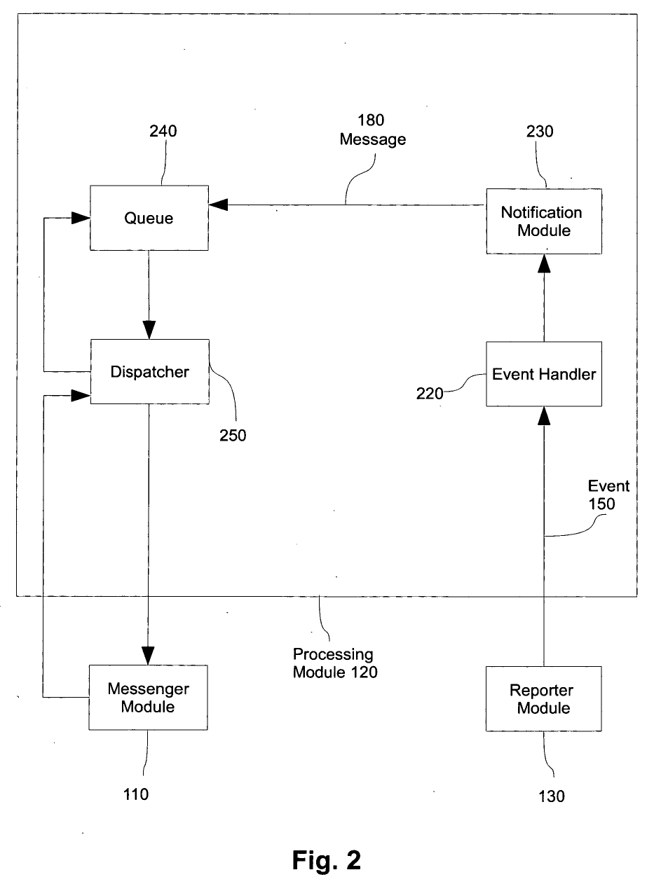

The communication between message module 110 and processing module 120 may be bi-directional. Message module 110 may send information to processing module 120. In one embodiment, message module 110 may send responses to processing module 120. The response may include any information related to messenger module 110, the subscriber associated therewith, and/or the messages sent by processing module 120 to messenger module 110. As a further embodiment, a response may include the status of a message sent by processing module 110. For example, such a response may be “delivery failure”. Processing module 120, after receiving the response from messenger module 110, may resend the failed message to messenger module 110. As a further example, messenger module 110 may sending a response to dispatcher 250 (see FIG. 2), which may subsequently order queue 240 to re-send any failed messages to messenger module 110.

As further shown in FIG. 1, monitoring environment 190 includes one or more subscribers 100. A subscriber 100 may comprise an application (e.g., a business application or software) that is physically or logically located at the monitoring environment 190. Each subscriber 100 is not limited to any specific type of application software for monitoring events related to resources 140. Examples of subscribers 100 include an ERP (Enterprise Resource Planning) application, a QM (Quality Management) system, and a WM (Warehouse Management) application, or a xMII (xApp Manufacturing Integration and Intelligence) application. Although examples of application software for subscribers 100 have been provided, subscribers 100 may comprise other components or hardware, such as a computer server, a computer desktop, a computer system, and/or any computer related hardware.

Each subscriber 100 may subscribe to a message for an event, so that the message, upon generation by computer system 180, is delivered to subscriber 100. The content of a message may include information related to the event and/or other information monitored by computer system 180. In accordance with an embodiment of the invention, events may be user-defined. By way of example, a user associated with one subscriber 100 (i.e., a “first subscriber”) may define an event based on attributes associated with a resource. One or more graphical user interfaces (GUI) accessed via console module 160 may enable the first subscriber to input data and/or make selections to define an event.

For example, when a first subscriber defines an event, the subscriber may decide what attributes to be involved in the defining event. The first subscriber may be presented with a list of attributes, in the form of one or more GUI objects such as pop up menus or text fields, after determining the resource 140 needed to be monitored. The attributes presented to the first subscriber may include all of the attributes that can be currently monitored by the reporter module 130 with respect to the corresponding resource 140. The one or more GUI objects may then allow the first subscriber to select any combinations of attributes of the resource 140. The one or more GUI objects may further allow the first subscriber to further define the event. For example, the first subscriber may determine the specific circumstances where an event should be generated. Also, the first subscriber may determine his or her own text messages to be included in the event. After the first subscriber completes defining an event associated with resource 140, messages may be sent to the first subscriber when the monitored events are determined to have occurred.

In addition, another subscriber 200 (i.e., a “second subscriber”) may access and view defined events via console module 160 and elect to subscribe to messages concerning those events. As a result, when monitored events are determined to have occurred, message may be sent to not only the first subscriber, but also the second subscriber and any other subscribers that elected to receive notification on the event. In accordance with an embodiment of the invention, event definitions by a first subscriber and message subscriptions by a second subscriber (as well as other subscribers) may be stored in processing module 120 based on input received through console module 160.

According to an aspect of the invention, messenger modules 110 can be used to deliver one or more messages generated by processing module 120 to respective subscribers 100. In one embodiment, each messenger module 110 is associated with one subscriber module 100. Communication between a messenger module 110 and a subscriber 100 is not limited to any specific type of connection or messaging protocol. By way of example, the connection between a messenger module 110 and a subscriber 100 may be made over an Internet or a secure intranet connection, such as private leased line. The connection between a messenger module 110 and a subscriber 100 may also be made over a wired or wireless connection, such as a GSM or 3G network. In addition, messenger module 110 may deliver messages to a subscriber 100 in any number of ways. Messages between a messenger module 110 and subscriber 120 may be based on any appropriate messaging protocol, such as Internet's Simple Mail Transfer Protocol (SMTP), IBM's SNADS, Novell's MHS, Lotus' cc:Mail, Microsoft's MS Mail, and X.400.

As with the association between reporter modules 130 and resources 140, each messenger module 110 may include a messenger module type that only matches the type of its associated subscriber 100. For example, a messenger module configured to support a subscriber, such as an ERP application, may not be used to communicate with a subscriber of a different type of application, such as an WM application.

FIG. 2 shows an exemplary embodiment of the processing module 120 and communication processes involving messenger module 110 and reporter module 130, consistent with an embodiment of the present invention. As shown in FIG. 2, processing module 120 may be implemented with a number of components, including a an event handler 220, a notification module 230, a queue, and a dispatcher 250. As with the components of computer system 180, each of these components may be implemented as software components. Although FIG. 2 shows a certain number of components, more than one of each type of component (event handler 220, a notification module 230, a queue, and a dispatcher 250) may be implemented for each reporter module 130 and/or messenger module 110 connected to processing module 120.

Referring to FIG. 2, event handler 220 receives events 150 from a reporter module 130. In one embodiment, each reporter module 130 has a corresponding event handler 220. In this way, events sent by a reporter module 130 are always received by a particular event handler counterpart. Thus, consistent with an embodiment, event handler 220 is not be shared by more than one reporter module 130. Events 150 may be implemented with a number of data structures and/or data formats. For example, event 150 may be programmed as a data object comprising one or more data elements of different data types such as integers, booleans, strings, arrays, and pointers. Data elements included in events 150 can then be sent by reporter modules 130 to event handlers 220.

Event handler 220 may be connected to one or more notification modules 230. When an event is received by event handler 220, event handler 220 interprets the event and passes the event to a notification module 230. In interpreting an event, event handler 220 identifies the correct notification module 230 for processing the event based on information included in the event. In one embodiment, event handler 220 identifies the notification module 230 that matches an attribute included in the event. Although not shown in FIG. 2, there may be a plurality of notification modules 230 that event handler 220 can select between for forwarding event 150. In one embodiment, there may be one notification module 230 for each type of event being monitored in the monitored environment 195.

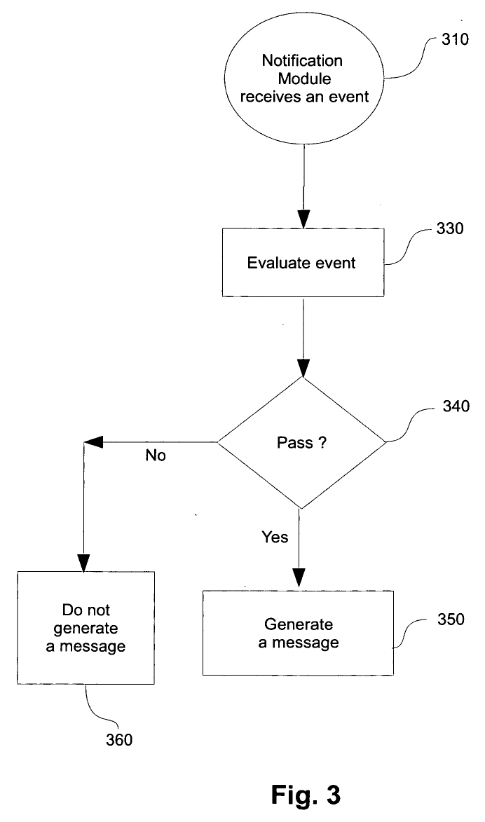

Notification module 230 is configured to receive events from event handler 220. When a notification module 230 receives an event from handle 220, the notification module 230 may determine if a message 180 should be generated to queue 240. In one embodiment, to determine if a message 180 should be generated, notification module 230 may evaluate the content of event 150 and determine if one or more predetermined expressions or rules are satisfied. If the evaluation passes, then a message is generated. Otherwise, if the evaluation fails, then no message is generated. An exemplary embodiment of performing an evaluation is discussed below with reference to FIG. 3. In addition to evaluating event 150 based on expressions or rules, other factors or criteria may be used by notification module 230 to determine whether to generate message 180. For example, notification module 230 may evaluate a table or database to determine the status or existence of a subscriber (i.e., any of subscribers 100) to subscribe to messages concerning an event. In one embodiment, the status of a subscriber may be active or inactive to control message flow.

Message 180 may include content concerning an event. One or more subscribers 100 may subscribe to receive messages related to an event. In addition, as indicated above, a subscriber that defines an event may opt to automatically receive messages concerning that event. In one embodiment, message 180 is generated by notification module 230 and include content concerning the event 150 received by the notification module 230. The content of a message to be generated may various information, such as the name or an identifier of the monitored resource 140, the name or an identifier of the monitored attribute, and/or a value corresponding to the monitored attribute. Alternatively, the content of a message may includes the name or an identifier of the monitored resource 140, the name or an identifier of the attribute for which the change took place, and the time of receiving an acknowledgement from resource 140. By way of example, the content of message 180 may be as follows: “Robot arm; failure rate, 50%; 24:00.” Messages may be implemented in any number of ways and data formats and, therefore, are not limited to specific data formats or specifications. In one embodiment, message 180 may be implemented in human readable format, such as XML, or machine readable format, such as digital or binary format. A message may also be encrypted or unencrypted.

Referring now to FIG. 3, a flow chart is provided of an exemplary method for controlling message delivery, consistent with an embodiment of the invention. The exemplary method of FIG. 3 may be performed when notification module 230 receives event 150 and determines whether to generate message 180.

When notification module 230 receives event 150 (step 310), an expression evaluator is invoked by notification module 230 to evaluate event 150 (step 330). The expression evaluator may be a routine or script that, when executed, evaluates event 150. In one embodiment, the evaluation may be based on a number of factors or criteria concerning monitored attribute(s). In another embodiment, the evaluation of event 150 is based on the presence of one or more predetermined expressions and/or other information included in event 150. A predetermined expression may include a value or rule concerning an attribute, such as a temperature value or range in the monitored environment 195. If the result of the evaluation passes, then a message is generated (step 350). If the result of the evaluation fails, then a message is not generated (step 360).

To further illustrate the evaluation of events 150 by notification module 230, assume an exemplary expression or rule as follows: “temperature less than 90 degrees.” If a temperature is a monitored attribute and a temperature of 80 degrees is received, then the evaluation passes (step 340; Yes) and a message is generated (step 350). If, however, the temperature is 100 degrees, as reflected by the content of event 150, then the evaluation fails and a message is not generated (step 360).

Referring again to FIG. 2, messages 180 generated for each notification module 230 are delivered to queue 240. Queue 240 may receive and provide a queue for all messages 180 generated by one or more notification modules 230 related a corresponding event handler 220 and reporter module 130. In other words, there may be one queue 240 for messages 180 generated based on events 150 from one reporter module 130. Each queue 240 handles the forwarding of messages 180 to one or more messenger modules 110. Each messenger module 110 may be provided with a corresponding subscriber 100 (see FIG. 1), with no messenger module 110 being shared by more than one subscriber 100. Consistent with an aspect of the invention, processing module 120 may include a dispatcher 250 for controlling the delivery of messages 180 from queue 240 to messenger module(s) 110. In one embodiment, there is one dispatcher 250 provided for each queue 240. The control of messages delivered from queue 240 may dependent on one or more factors, such as the number of messages 180 in queue 240 and/or specified messaging intervals.

In accordance with an embodiment of the invention, each messenger module 110 may be configured to receive messages from message queue 240 via dispatcher 250 at any time without prior notice. In addition, each messenger module 110 may be configured to receive one message at a time or receive a plurality of messages from one or more message queues 240 via one or more dispatchers 250 at any time.

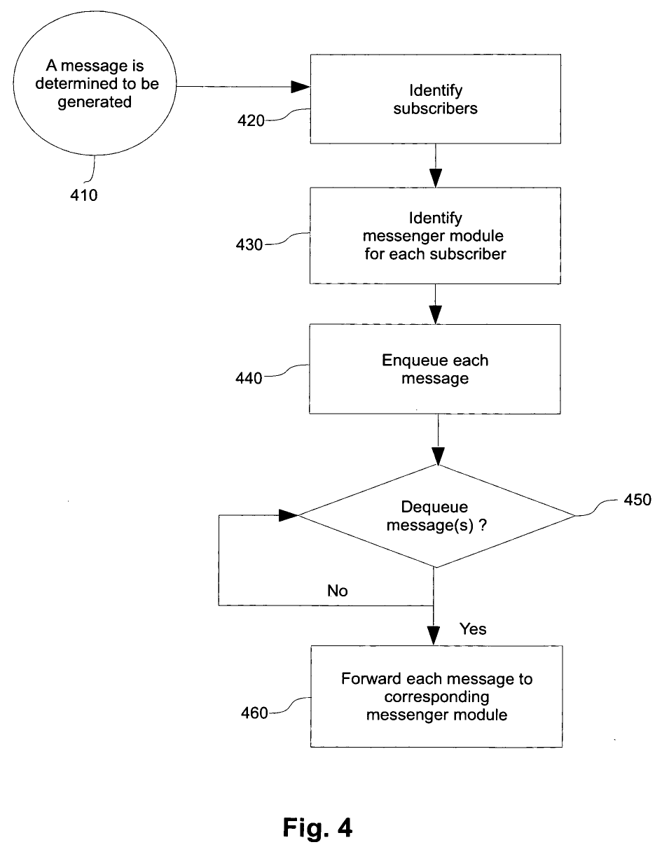

Referring to FIG. 4, a flow chart is provided of an exemplary method for generating and forwarding messages to messenger module(s) 110 via dispatcher 250. The exemplary method of FIG. 4 may be performed once a message 180 is determined to be generated by notification module 230 (step 350; FIG. 3).

As shown in FIG. 4, after a message is determined to be generated by a notification module 230, subscribers 100 to receive the message are identified (step 420). In one embodiment, notification module 230 identifies each subscriber 100 by referring to a list of subscribers associated with an event. In one embodiment, a data store or database may be implemented in processing module 120 and accessed by notification module 230 to identify each subscriber 100 associated with an event. A data store in XML or a database with a relational table may include information that groups subscribers to each event type. A subscriber may receive a message for an event by optionally subscribing to an event or defining an event and automatically receiving messages for the event that the subscriber defined.

Based on the identified subscribers, notification module 230 may identify each corresponding messenger module 110. Consistent with an aspect of the invention, one messenger module 110 may be assigned to each subscriber 100. Information concerning assignments or associations between messenger modules 110 and subscriber 100 may stored in a data store (XML) or a database (relational table). By way of example, if three subscribers (100-1, 100-2, and 100-3) are identified to receive a message for an event, the corresponding messenger modules (110-1, 110-2, 110-3) may be identified to ensure proper forwarding of the message (step 430).

After the messenger modules are identified (step 430), notification module 230 generates message 180 for each subscriber, with the corresponding message 180 for each subscriber including content identifying the appropriate messenger module 110 for forwarding the message to the subscriber. Thus, messages 180 include content concerning an event, as well as address or delivery information for forwarding the message to a subscriber 100 via a messenger module 110. Each of the generated messages are placed into queue 240, where they are enqueued (step 440). In one embodiment, message queue 240 may hold each enqueued message and wait for other messages 180 from notification module 240. When a dequeued signal is received from dispatcher 250 (step 450; Yes), message queue 240 will empty its queue of messages and forward each message 180 to a corresponding messenger module 110 (step 460) that was identified for a subscriber 100 (step 440).

Consistent with certain embodiments of the present invention, messenger modules 110 may be enabled to send event notifications concerning resources, in the form of messages, to subscribers 110. The exemplary method of FIG. 4, described above, illustrates a process for sending such messages to subscribers 110.

In accordance with an additional embodiment, information such as commands related to resource 140, may be sent by subscriber 100 to resource 140 via an interface (not shown). The interface may comprise an Application Programming Interface (API) provided by computer system 180, or a published service interface such as a web services interface. In one embodiment, an interface is provided for sending commands to each resource 140.

The present techniques and embodiments described herein, including the exemplary systems and methods presented above, can be implemented in digital electronic circuitry, or in computer hardware, firmware, software, or in any suitable combinations thereof. In addition, apparatus and systems consistent with the present invention can be implemented in a computer program product tangibly embodied in a machine-readable storage device for execution by a programmable processor.

Method steps according to embodiments of the invention can be performed by a programmable processor executing a program of instructions to perform functions or steps of the methods by operating based on input data, and by generating output data. Embodiments of the invention may also be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, or in assembly or machine code. The language or code can be a compiled or interpreted language or code. Processors may include general and special purpose microprocessors. A processor receives instructions and data from memories, in particular from read-only memories or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in application-specific integrated circuits (ASICs).

To provide for interaction with a user, aspects of the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g., an RF communication link). A display is coupled to an interface, which is coupled to an I/O bus. A keyboard and pointing device are also coupled to the I/O bus. Alternatively, separate buses may be used for the keyboard pointing device and I/O interface.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Although illustrative embodiments have been described herein with reference to the accompanying drawings, it is noted that the invention is not limited to the precise system and method embodiments described herein, and that various other changes and modifications may be affected by one skilled in the art without departing from the scope or spirit of the invention. All such changes and modifications are intended to be included within the scope of the invention as defined by the appended claims.

What is claimed is:

1. A computerized method for real-time data notification, comprising:
defining an event related to a resource in accordance with input from a first subscriber;
allowing a second subscriber to subscribe to a message concerning the event defined by the first subscriber;
receiving data generated by a reporter module, the reporter module being configured to monitor at least one attribute of the resource;
interpreting the data generated by the reporter module to determine the occurrence of the event defined by the first subscriber;
delivering, when it is determined that the event has occurred, a message to the first subscriber, the message including content concerning the event; and
additionally delivering the message concerning the event to the second subscriber.

2. The computerized method in claim 1, wherein delivering the message to both the first and second subscribers further comprises using a queue, a dispatcher, or a message handler.

3. The computerized method in claim 1, further comprising:
sending a command from the first subscriber to the reporter module after receiving the message, the command relating to the resource.

4. The computerized method in claim 1, wherein allowing the second subscriber to subscribe to the message further comprises using a web service.

5. The computerized method in claim 1, wherein the determination of whether the message should be delivered is based on a predetermined schedule.

6. The computerized method in claim 1, wherein the determination of whether the message should be delivered is based on the received event.

7. The computerized method in claim 1, wherein the determination of whether the message should be delivered is based on an expression provided by the first subscriber.

8. The computerized method in claim 1, wherein the message further includes the at least one attribute of the resource.

9. The computerized method in claim 1, wherein the at least one attribute further comprises a data value, a process exception, or a quality issue.

10. The computerized method in claim 1, wherein the resource further relates to an automation equipment, a measuring device, or an automatic ID device.

11. The computerized method in claim 1, wherein the event further relates the resource and the name and value of the at least one attribute.

12. A system for data processing, comprising:
a console module configured to allow a subscriber to define an event;
a reporter module configured to monitor at least one attribute of a resource and to generate data;
a processing module configured to
receive data generated by the reporter module;
interpret the data generated by the reporter module and to determine the occurrence of the event defined by the subscriber; and
a messenger module configured to deliver, when it is determined that the event has occurred, the message to the subscriber.

13. The system of claim 12, wherein the messenger module is further configured to deliver the message using a queue, a dispatcher, or a message handler.

14. The system of claim 12, wherein both the first and second subscribers are further configured to send a command from the first subscriber to the reporter module after receiving the message, the command relating to the resource.

15. The system of claim 12, wherein the second subscriber is further configured to subscribe to the message further comprises using a web service.

16. The system of claim 12, wherein the processing module is further configured to determine whether the message should be delivered based on a predetermined schedule.

17. The system of claim 12, wherein the processing module is further configured to determine whether the message should be delivered based on the received event.

18. The system of claim 12, wherein the processing module is further configured to determine whether the message should be delivered based on an expression provided by the first subscriber.

19. The system of claim 12, wherein the message further includes the at least one attribute of the resource.

20. The system of claim 12, wherein the at least one attribute further comprises a data value, a process exception, or a quality issue.

21. The system of claim 12, wherein the resource further relates to an automation equipment, a measuring device, or an automatic ID device.

22. The system of claim 12, wherein the event further relates to the resource and the name and value of the at least one attribute.

23. A computer readable storage medium comprising programmable instructions adapted to perform a computer-implemented method for data processing, comprising:
defining an event related to a resource in accordance with input from a first subscriber;
allowing a second subscriber to subscribe to a message concerning the event defined by the first subscriber;
receiving data generated by a reporter module, the reporter module being configured to monitor at least one attribute of the resource;
interpreting the data generated by the reporter module to determine the occurrence of the event defined by the first subscriber;
delivering, when it is determined that the event has occurred, a message to the first subscriber, the message including content concerning the event; and
additionally delivering the message concerning the event to the second subscriber.

24. The storage medium of claim 23, wherein delivering the message to both the first and second subscribers further comprises using a queue, a dispatcher, or a message handler.

25. The storage medium of claim 23, further comprising:
sending a command from the first subscriber to the reporter module after receiving the message, the command related to the resource.

26. The storage medium of claim 23, wherein allowing the second subscriber to subscribe to the message further comprises using a web service.

27. The storage medium of claim 23, wherein the determination of whether the message should be delivered is based on a predetermined schedule.

28. The storage medium of claim 23, wherein the determination of whether the message should be delivered is based on receiving the event generated by the reporter module.

29. The storage medium of claim 23, wherein the determination of whether the message should be delivered is based on an expression provided by the first subscriber.

30. The storage medium of claim 23, wherein the message further includes the at least one attribute of the resource.

31. The storage medium of claim 23, wherein the at least one attribute further comprises a data value, a process exception, or a quality issue.

32. The storage medium of claim 23, wherein the resource further relates to an automation equipment, a measuring device, or an automatic ID device.

33. The storage medium of claim 23, wherein the event further relates to the resource and the name and value of the attribute.
